(19) United States
(12) Patent Application Publication
(10) Pub. No.: US 2010/0177667 A1
(43) Pub. Date: Jul. 15, 2010

(54) Audio conferencing with integrated access point

(76) Inventor: Gordon S. Simmons, Scotts Valley, CA (US)

Correspondence Address: PLANTRONICS, INC.;IP Department/Legal, 345 ENCINAL STREET, P.O. BOX 635, SANTA CRUZ, CA, 95060-0635, US

(21) Appl. No.: 11/317,164

(22) Filed: Dec. 23, 2005

(51) Int. Cl. H04W 4/00

(52) U.S. Cl. 370/260

(57) ABSTRACT

The present invention provides a conference access point system and method allowing for audio conference sessions as well as access to local and wide area networks via an integrated access point. Advantageously, efficient and cost-effective audio conferencing and network access is provided with optional presence notification, signal processing, and security.

### TECHNICAL FIELD

The present invention relates generally to audio conferencing and, more particularly, to an audio conferencing system and method with an integrated access point.

### BACKGROUND

The ability for groups of people to convene and communicate in central business locations is one of the highest value areas of telecommunications. Globalization and distributed, mobile workforces make the conference room an essential, and often daily part of professional work. Trends for audio conferencing minutes of use are projected to continue to grow at double digit rates for the foreseeable future.

Most business environments have conference rooms with audio conferencing capabilities (e.g., speakerphones), and most have network (e.g., Ethernet, Internet) connectivity, but the trend has been for separate conference equipment and access point “boxes” to be placed at different locations around the office. Thus, audio conferencing and access point capabilities have been previously provided by separate vendors, separate installations, and separate devices, leading to inefficiencies and higher costs.

Thus, an audio conferencing system and method utilizing an integrated access point is highly desirable.

### SUMMARY

The present invention provides a conference access point system and method allowing for audio conference sessions as well as access to local and wide area networks via an integrated access point.

In accordance with an embodiment of the present invention, an audio conferencing system is provided, the system including a conference access point including a speakerphone integrated with an access point, and a wireless device operably coupled to the conference access point, thereby allowing the wireless device to be operably coupled to a local area network.

In accordance with another embodiment of the present invention, an audio conferencing system is provided, the system including a conference access point including a speakerphone integrated with an access point, an Ethernet operably coupled to the conference access point and the Internet, and a VoIP headset operably coupled to the conference access point via the IEEE 802.11 protocol, thereby being operably coupled to the Ethernet.

In accordance with yet another embodiment of the present invention, a method of audio conferencing is provided, the method including providing a conference access point in a conference room, the conference access point including a speakerphone integrated with an access point. The method further includes coupling the conference access point to a local area network, coupling the local area network to a wide area network, and coupling a wireless device to the conference access point.

Advantageously, the present invention provides for efficient and cost-effective audio conferencing and network access with optional presence notification, signal processing, and security.

The scope of the invention is defined by the claims, which are incorporated into this section by reference. A more complete understanding of embodiments of the present invention will be afforded to those skilled in the art, as well as a realization of additional advantages thereof, by a consideration of the following detailed description of one or more embodiments. Reference will be made to the appended sheets of drawings that will first be described briefly.

### BRIEF DESCRIPTION OF THE DRAWINGS

FIG. 1 shows an audio conferencing system including a conference access point and wireless devices in accordance with an embodiment of the present invention.

FIG. 2 shows a block diagram of a conference access point in accordance with an embodiment of the present invention.

Embodiments of the present invention and their advantages are best understood by referring to the detailed description that follows. It should be appreciated that like reference numerals are used to identify like elements illustrated in one or more of the figures. It should also be appreciated that the figures may not be necessarily drawn to scale.

### DETAILED DESCRIPTION

The present invention provides for a conference telephone (including a speakerphone) integrated with an access point, thereby providing what will be called a conference access point (CAP). Advantageously, the present invention allows for a single product to serve audio conferencing needs as well as provide Internet access (e.g., via IEEE 802.11) at an important physical location in most businesses. The layout of conference rooms in many companies is such that they are distributed around work areas. For example, a conference room will be near a team or department work area, and in one example may be located near the corners of the floor or in the middle of the floor, such that the present invention will provide wireless Internet access across many business floor plans in an adequate way. Thus, conference meeting attendees will be able to connect via a wireless device (e.g., a laptop, a PDA, a cellular phone, a smartphone, or an IEEE 802.11 based VoWiFi headset) with guaranteed signal strength while in the important meeting, thus saving time and improving common data sharing activities.

The wireless device may also be used to signal and access conferencing specific features of the CAP. For example, after identification of a conference attendee, the CAP may change that attendee's status to “in a meeting” in a schedule software, such as Microsoft Corporation's Outlook®. This feature may be provided in concert with another service, such as a SIP Proxy registrar, as embodied in Siemens's OpenScape™ or similar service. Thus, the CAP allows for presence awareness and detection capability for the meeting. Another optional feature is that the summed call in progress may be sent directly to a person with a hearing impairment who is wearing an 802.11 headset so that the person can hear the call better. Accordingly, the CAP has information of other devices that are part of the conference session, and may then use that information in an application. The CAP may also have specific security measures associated with meeting agendas and attendees for more secure computing, such as encryption and the use of passwords. For example, in one instance, a meeting may not be allowed to occur unless a quorum is present. Thus, the CAP may have to have sufficient attendance to satisfy this requirement. The attendees may have to be at the access point, and then are asked to securely login to the meeting with their ID or password. The meeting would not proceed until the attendees have securely logged in on their 802.11 device to the CAP.

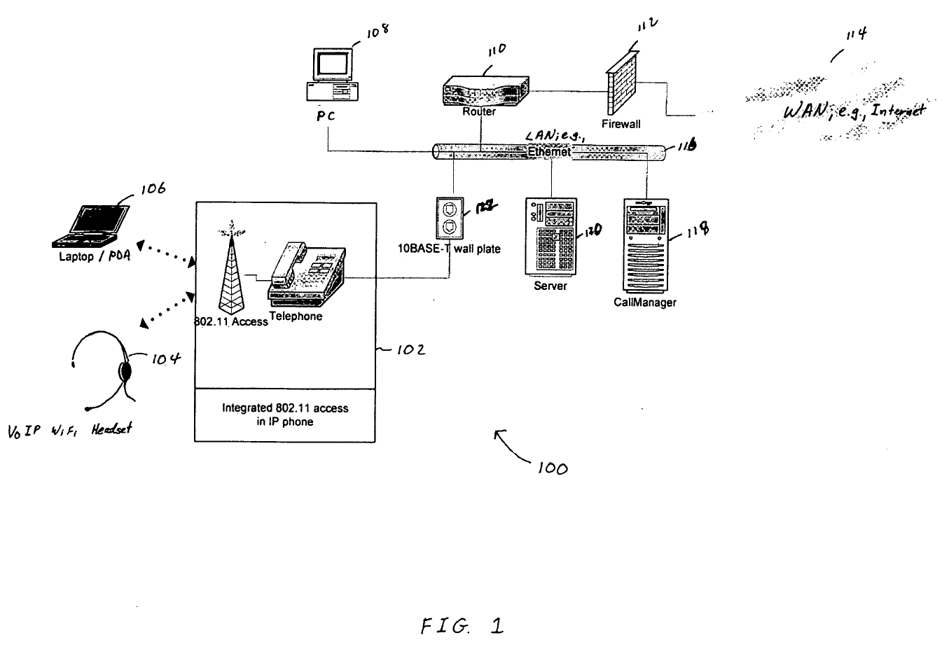

Referring now to FIG. 1, an audio conferencing system 100 is shown including a conference access point (CAP) 102 and wireless devices in accordance with an embodiment of the present invention. Examples of wireless devices include but are not limited to a VoIP WiFi headset 104, a laptop/PDA 106, and a cellular telephone (not shown). CAP 102 is wired to a local area network (LAN) 116, such as an Ethernet, via interface means 122, such as a RJ45 jack and a 10Base-T wall plate in the conference room. Optionally, a personal computer 108, a router 110, a call manager 118, and a call server 120 may be operably coupled to LAN 116, and a wide area network (WAN) 114 such as the Internet may be operably coupled to LAN 116 via router 110 and an optional firewall 112. These components may be utilized to manage CAP 102. In one example, CAP 102 is able to support wireless fidelity (WiFi) in general, and the IEEE 802.11 wireless networking standard in particular, but other protocols for wireless communication are within the scope of the present invention.

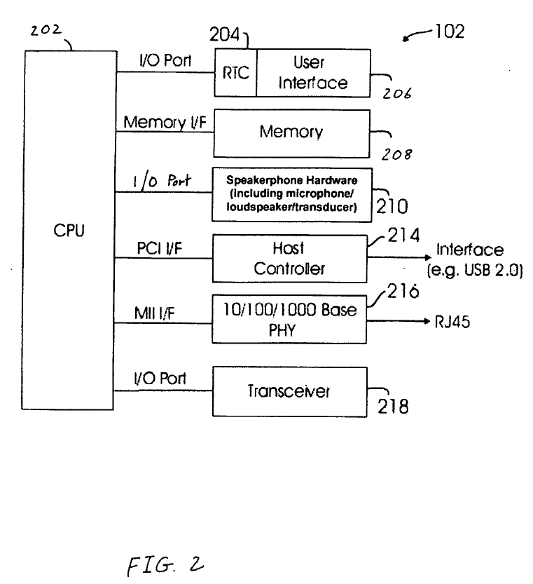

Referring now to FIG. 2 in conjunction with FIG. 1, a block diagram of an example of CAP 102 is shown in accordance with an embodiment of the present invention. CAP 102 includes a central processing unit (CPU) 202 operably coupled to: a real-time clock (RTC) 204 and a user interface 206 via an input/output port; a memory 208 (e.g., SDRAM or flash memory) via a memory interface; Internet Protocol (IP) speakerphone hardware 210 via an input/output port; a LAN connector 216 (e.g., a 10/100/1000 Base-T Ethernet port) via a MII interface; and a transmitter/receiver (transceiver) 218 via an input/output port. A host controller 214 (e.g., a Universal Serial Bus (USB) host controller) may optionally be coupled to CPU 202 via a peripheral component interconnect (PCI) interface.

CPU 202 is a high performance, highly integrated, and highly flexible system-on-chip (SOC) in one example, including signal processing functionality such as echo cancellation/reduction and gain control in another example. CPU 202 may include a variety of processors (e.g., digital signal processors), conventional CPUs being applicable and commercially available.

RTC 204 may be utilized to provide audio conferencing information or parameters based upon time (e.g., password expiration time and/or date or conference schedule).

User interface 206 is operably coupled to processor 202 for displaying CAP functionality to the user, and in one example includes a light emitting diode (LED) or display system. In one example, LEDs may be used to indicate different functions or status of CAP 102. For example, an LED may be on when the apparatus is powered on and ready for use or off when the device is powered off. An LED may blink when the device is booting up or shutting down or an LED may also indicate connection to and/or operation with a LAN, a WAN, and/or a portable storage device such as a USB flash drive. In one embodiment, firmware and hardware may be used in conjunction with the LED(s) to indicate status of the CAP, connection to and operation with the LAN, the WAN, and other functions of the CAP. In another embodiment, user interface 206 may include an alpha-numeric keypad and screen for entering parameters, telephone numbers, names, or other information regarding conference sessions.

Memory 208 may include a variety of memories, and in one example includes SDRM, ROM, flash memory, or a combination thereof. In one example, memory 208 may be used to store passwords, network and telecommunications programs, and/or an operating system (OS). In order to access the call processing features, CAP 102 includes a basic input/output system (BIOS) and any of several discovery protocols in memory 208 to instantiate the device presence on LAN 116. Additionally, CAP 102 includes the ability to download various protocols which define the class of features the telephone will invoke in the communication sessions. These protocols are maintained on network servers, for example server 120. To incorporate access point features, CAP 102 may include the 802.11 protocol and signaling capabilities for an 802.11 access point via transceiver 218. To incorporate conference call features, CAP 102 may include the H.323 IP conference protocol. Other protocols for conference call and access point features are within the scope of the present invention.

Speakerphone hardware 210 includes hardware for the conference call function, including but not limited to a microphone, speaker, and/or transducer for transmitting/receiving sound to/from conference attendees or wireless device users.

Host controller 214 may include a storage device interface, which may be a USB 2.0 interface in one example. The storage device interface may be used to connect to memory cards and/or flash drives. In particular, a storage device interface may receive a storage device including a list of attendee names, conference schedules, and/or telephone numbers. The list may be provided from various sources, including but not limited to client computer 108. It is noted that the predetermined list may be provided to CAP 102 by other methods as well (e.g., via wireless device or the CAP user interface). Host controller 214 is not limited to a single storage device interface or the USB 2.0 interface and may include a greater number and/or different types of interfaces (e.g., PCMCIA).

LAN interface 216 provides for connection of CAP 102 to a LAN, and in one example supports the 10/100/1000 Base-T standards, automatic negotiation, and automatic medium dependent interface crossover (MDIX). In a further example, LAN interface 216 includes a Ethernet RJ-45 port which can be coupled via cable to interface means 122 (FIG. 1).

Transceiver 218 is a device that both transmits and receives/detects digital and/or analog signals, and in the context of the present invention is able to detect wireless signals from a wireless device requesting access to a network, and is further able to detect signals through a network wire and apply signals onto the network wire.

Wireless devices, such as headset 104 and laptop/PDA 106 can then gain access to LAN 116 and WAN 114 via CAP 102 using one of various wireless protocols, including IEEE 802.11. Applicable VoIP headsets are commercially available from Plantronics, Inc. of Santa Cruz, Calif.

CAP 102 may further include line speed switching capability so that a computer can be added to the IP phone and a single CAT5 drop can serve a location. In this case the switching is to the 802.11 access point, giving devices that attach to CAP 102 true line speed (e.g., 10/100bT) access to the data network. The devices then share power and can operate simultaneously on the network.

An example of how a session might occur can be seen below in a description of a Session Initiation Protocol (SIP), a signaling protocol for Internet conferencing, telephony, presence, events notification, and instant messaging. The following example request messages are defined by the core SIP:

“INVITE” invites a participant to a session;

“BYE” ends a client's participation in a session;

“CANCEL” terminates a transaction;

“OPTIONS” queries a participant about their media capabilities;

“ACK” is for reliability and call acceptance (e.g., a 3-way handshake); and

“REGISTER” informs a SIP server about the location of a user.

In one example of a basic conference session between two devices, CAP 102 may INVITE the 802.11 headset 104 (or other wireless device such as laptop/PDA 106) to the session. The 802.11 headset 104 would then acknowledge (ACK) and REGISTER with CAP 102. There is an implied authentication therein, which could be done with headset media access control (MAC) or IP addressing schemes specific to headsets as a class. Optionally, the CAP and 802.11 devices may also define a media type, such as conferencing speech, which would invoke the echo canceller at the CAP and add signal processing such as volume logic signal processing which automatically levels the gain (loudness) in the conference. An ACK follows, allowing all the devices to engage in a conferencing speech session. In accordance with an embodiment of the present invention, firmware in CAP 102 is capable of sending information regarding the conference (e.g., present or linked wireless devices) to various providers or servers. REGISTER information is sent by CAP 102 to other services, such as presence services, to update the status of headset 104 to the state of being in a conference session. In this scenario the CAP then is a SIP user and client, and is an aggregator of presence and session status to report to other services.

The present invention thus provides for several advantages.

1. The integration of an 802.11 access point in terms of incremental cost is relatively low vis-a-vis the market price of the speakerphone.

2. CAP 102 shares Ethernet connectivity resources with VoIP aspects of the speakerphone. As VoIP traffic has the means to command high network bandwidth, VoIP speakerphones can have a true line speed switch in them (see, e.g., Broadcom and Texas Instruments VoIP chips currently available), thus allowing for efficient and fast network connectivity for devices (wireless or wired) connected via CAP 102.

3. The location of conference rooms tends to be a central location where a high degree of connectivity is needed. Conference rooms also tend to be distributed in a way that coincides with the area of typical 802.11 access points.

4. The IP speakerphone has an O/S, and the trend is to move to more capable O/S in the future.

5. The speakerphone could then provide MMI information as to who has connected. In the case of an embedded Windows O/S, this could be linked to the calendar and resources for that meeting.

6. Users of 802.11 headsets for mobility can be authenticated and their presence registered with any of the instant messaging and presence servers as a change in presence state; e.g., to “IN A MEETING” when a headset is linked to CAP 102.

7. The need for security in conferences and meetings is currently not addressed by application specific appliances used in the conference room. The present invention provides means for such security.

8. Since the conference room resources are not personal, they lend themselves to IT oversight.

9. For a small company, the deployment of 802.11 access points can coincide with outfitting the conference room with the necessary speakerphone of this invention. The invention saves installing 802.11 in the ceiling, etc.

10. VoIP instruments get their protocols after the network discovers them; the ability to reflash and load new software for connected wireless devices and CAP 102 is built in. This allows updates for 802.11 access and the VoIP features from the network resources at any time, saving on administration of critical updates.

Embodiments described above illustrate but do not limit the invention. It should also be understood that numerous modifications and variations are possible in accordance with the principles of the present invention. Accordingly, the scope of the invention is defined only by the following claims.

We claim:

1. An audio conferencing system, comprising:
a conference access point including a speakerphone integrated with an access point; and
a wireless device operably coupled to the conference access point, thereby allowing the wireless device to be operably coupled to a local area network.

2. The system of claim 1, wherein the conference access point further includes a transceiver, a local area network interface, a microphone, a speaker, a processor, a memory, and a user interface.

3. The system of claim 1, wherein the local area network supports the Ethernet protocol.

4. The system of claim 1, wherein the wireless device is selected from the group consisting of a VoIP headset, a laptop, a cellular telephone, and a PDA.

5. The system of claim 1, wherein the wireless device is operably coupled to the conference access point via the IEEE 802.11 protocol.

6. The system of claim 1, further comprising a call server, a call manager, a personal computer, and a router operably coupled to the local area network for managing the conference access point.

7. An audio conferencing system, comprising:
a conference access point including a speakerphone integrated with an access point; and
a VoIP headset operably coupled to the conference access point via the IEEE 802.11 protocol, thereby being operably coupled to an Ethernet.

8. The system of claim 7, wherein the conference access point further includes a transceiver, a local area network interface, a microphone, a speaker, a processor, a memory, and a user interface.

9. The system of claim 7, further comprising a call server, a call manager, a personal computer, and a router.

10. A method of audio conferencing, the method comprising:
providing a conference access point in a conference room, the conference access point including a speakerphone integrated with an access point;
coupling the conference access point to a local area network;
coupling the local area network to a wide area network; and
coupling a wireless device to the conference access point.

11. The method of claim 10, wherein the conference access point further includes a transceiver, a local area network interface, a microphone, a speaker, a processor, a memory, and a user interface.

12. The method of claim 10, wherein the local area network supports the Ethernet protocol.

13. The method of claim 10, wherein the wireless device is selected from the group consisting of a VoIP headset, a laptop, a cellular telephone, and a PDA.

14. The method of claim 10, wherein the wireless device is operably coupled to the conference access point via the IEEE 802.11 protocol.

15. The method of claim 10, further comprising coupling a call server, a call manager, a personal computer, and a router to the local area network to manage the conference access point.

16. The method of claim 15, further comprising notifying the call server that the wireless device is operably coupled to the conference access point.

17. The method of claim 10, further comprising inviting the wireless device to join a conference session prior to coupling the wireless device to the conference access point.

18. The method of claim 10, further comprising authenticating and registering the wireless device prior to coupling the wireless device to the conference access point.

19. The method of claim 10, further comprising accessing the local area network and the wide area network via the conference access point during a conference session.

20. The method of claim 10, further comprising updating software for the wireless device via the conference access point.
